(19) United States
(12) Patent Application Publication
(10) Pub. No.: US 2025/0256563 A1
(43) Pub. Date: Aug. 14, 2025

(54) COOLING SYSTEM FLUID DISTRIBUTION MANIFOLD

(71) Applicant: Stoneridge Control Devices, Inc., Novi, MI (US)

(72) Inventors: Benjamin Allen Harriger, Bellville, OH (US); Grant Wheeler, El Paso, TX (US)

(21) Appl. No.: 19/045,264

(22) Filed: Feb. 4, 2025

Related U.S. Application Data
(60) Provisional application No. 63/553,352, filed on Feb. 14, 2024.

(51) Int. Cl. B60K 11/02; B60H 1/00; H01M 10/48; H01M 10/613; H01M 10/625; H01M 10/63; H01M 10/6568

(52) U.S. Cl. CPC B60K 11/02; B60H 1/00278; H01M 10/486; H01M 10/613; H01M 10/625; H01M 10/63; H01M 10/6568; B60H 2001/00307; H01M 2220/20

(57) ABSTRACT

A fluid distribution manifold for a vehicle cooling system includes a housing that includes a primary passageway that extends between a primary inlet and a primary outlet configured to be in fluid communication with a main cooling loop, the housing has multiple secondary passageways each fluidly connected to the primary passageway at a secondary inlet, the multiple secondary passageways each have a secondary outlet that is configured to be in fluid communication with a zone cooling loop, multiple valves that are supported by the housing, each of the secondary passageways have one of the multiple valves arranged fluidly between the secondary inlet and the secondary outlet to regulate fluid flow through its respective secondary passageway, and a least one temperature sensor or pressure sensor in fluid communication with the primary passageway.

### CROSS-REFERENCE TO RELATED APPLICATION

This application claims priority to U.S. Provisional Application No. 63/553,352 filed Feb. 14, 2024.

### TECHNICAL FIELD

This disclosure relates to a cooling system suitable for such vehicles as those using an electrified and/or hybrid powertrain.

### BACKGROUND

A typical modern vehicle includes various components and subsystems for which it is desirable to regulate the temperature (i.e., heating and/or cooling to a desired temperature). One or more cooling loops include one or more heat exchangers through which one or more fluids are circulated in a controlled manner to provide cooling fluid at a desired temperature to the components. As vehicles have become more complex, the complexity of the cooling system has increased as well.

A typical cooling system found in vehicles such as those having electrified and/or hybrid drivetrains tend to be highly distributed architectures with a complex maze of cooling loops, sub-loops, pumps, and heat exchanges. Coolant distributor valves, controllers and temperature sensors used to direct the coolant through these cooling systems are separated from one another and distributed throughout the vehicle. The resultant cooling system is complicated and expensive to implement and maintain, and the coolant temperature may not be as accurately regulated as desired.

### SUMMARY

In one exemplary embodiment, a fluid distribution manifold for a vehicle cooling system includes a housing that includes a primary passageway that extends between a primary inlet and a primary outlet configured to be in fluid communication with a main cooling loop, the housing has multiple secondary passageways each fluidly connected to the primary passageway at a secondary inlet, the multiple secondary passageways each have a secondary outlet that is configured to be in fluid communication with a zone cooling loop, multiple valves that are supported by the housing, each of the secondary passageways have one of the multiple valves arranged fluidly between the secondary inlet and the secondary outlet to regulate fluid flow through its respective secondary passageway, and a least one temperature sensor or pressure sensor in fluid communication with the primary passageway.

In a further embodiment of any of the above, the at least one temperature sensor or pressure sensor includes at least one temperature sensor and at least one pressure sensor mounted to the housing.

In a further embodiment of any of the above, the manifold includes a pump that is mounted to the housing and in fluid communication with the primary passageway and configured to circulate a coolant through at least one of the main cooling loop and the zone cooling loop.

In a further embodiment of any of the above, the manifold includes at least three secondary passageways. The multiple valves include at least three valves.

In a further embodiment of any of the above, the manifold includes at least four secondary passageways. The multiple valves include at least four valves.

In a further embodiment of any of the above, the multiple valves are each provided by a solenoid valve.

In a further embodiment of any of the above, the multiple valves are removably mounted on an exterior of the housing.

In a further embodiment of any of the above, the manifold includes a controller that is mounted to the housing. The controller is in communication with the multiple valves and configured to command a position of each of the multiple valves.

A vehicle cooling system that includes the fluid distribution manifold, the system includes the main cooling loop and the multiple zone cooling loops. The multiple zone cooling loops fluidly interconnect the housing and the main cooling loop.

In a further embodiment of any of the above, the system includes at least one heat exchanger fluidly arranged in the main cooling loop.

In a further embodiment of any of the above, the system includes a temperature sensor in communication with each of the multiple zone cooling loops.

In a further embodiment of any of the above, the multiple zone cooling loops include at least two of a battery, a vehicle cabin, a charging electronics and a motor.

In a further embodiment of any of the above, the multiple zone cooling loops include at least three of a battery, a vehicle cabin, a charging electronics and a motor.

In a further embodiment of any of the above, the multiple zone cooling loops include a battery, a vehicle cabin, a charging electronics and a motor.

In a further embodiment of any of the above, a coolant is provided in the main cooling loop and the multiple zone cooling loops, the coolant is a water ethylene glycol.

### BRIEF DESCRIPTION OF THE DRAWINGS

The disclosure can be further understood by reference to the following detailed description when considered in connection with the accompanying drawings wherein:

FIGS. 1A-1C are schematics of several example vehicle cooling systems.

FIG. 2 is a schematic of a disclosed fluid distribution manifold in relation to a cooling system.

FIG. 3 schematically illustrates the fluid distribution manifold.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

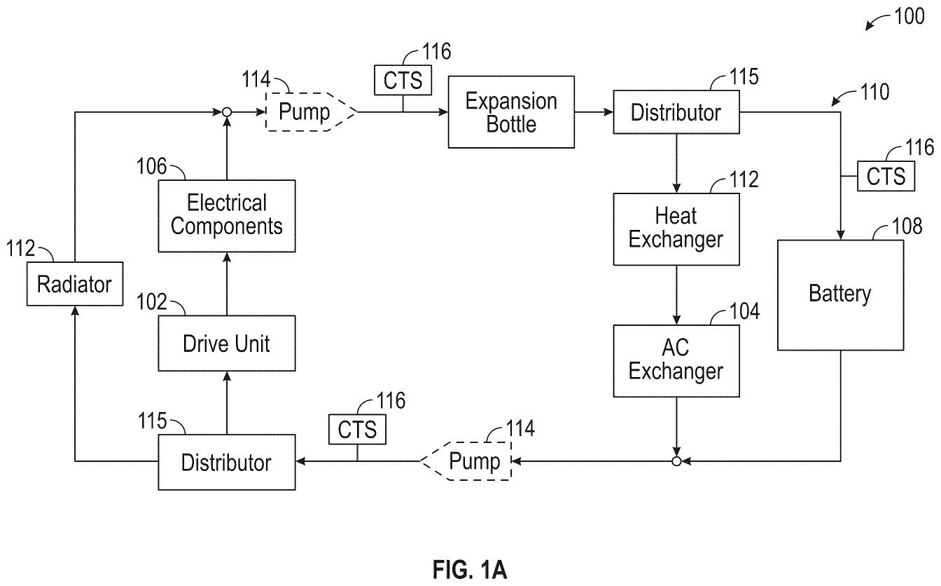

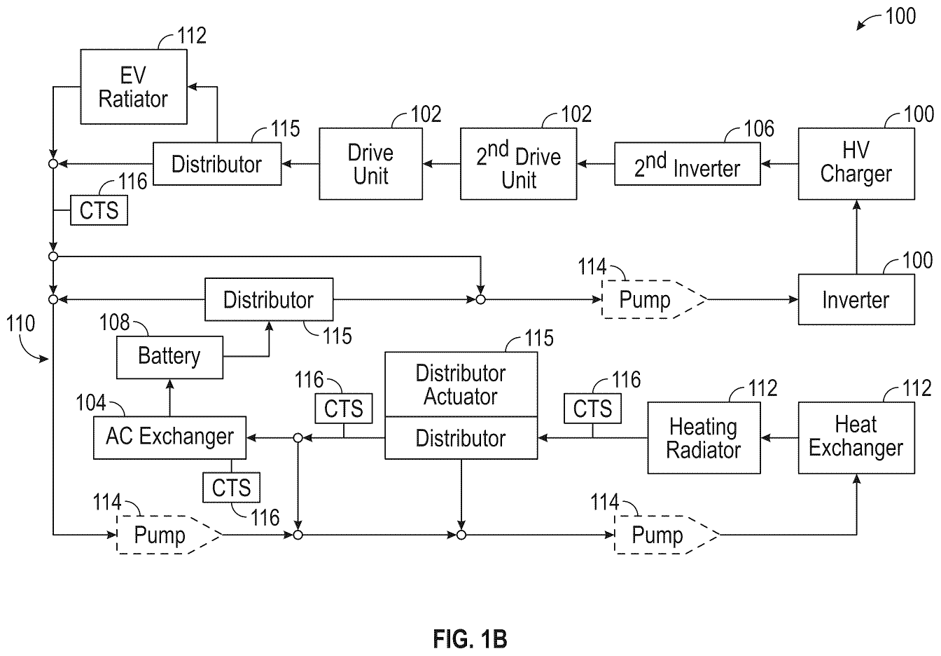

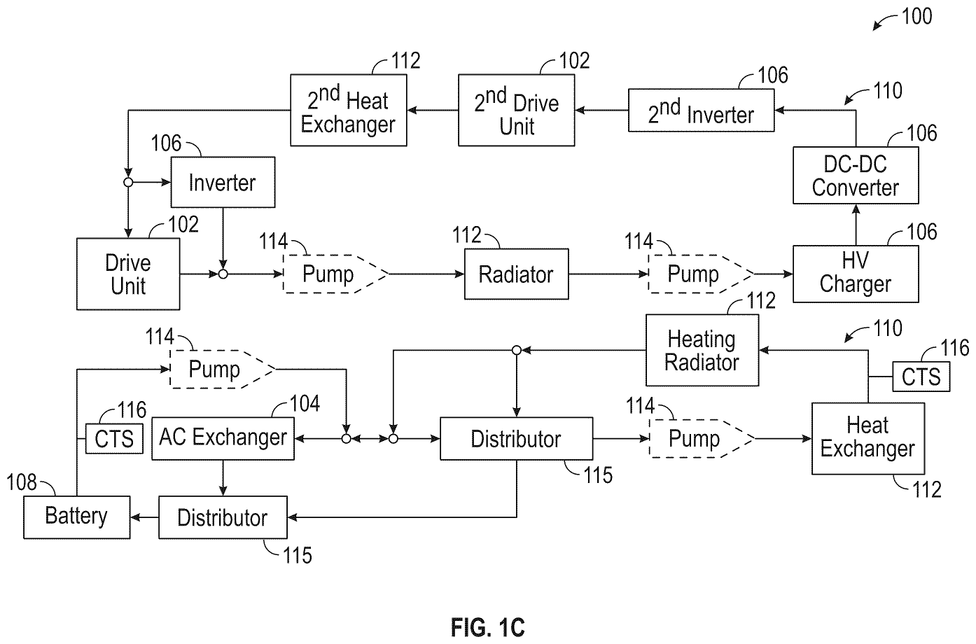

FIGS. 1A-1C, highly schematic and for illustrative purposes only, depict some aspects of typical example vehicle cooling systems 100. These cooling systems 100 tend to be relatively complex and include numerous loops, sub-loops, and branches for carrying a cooling fluid, such as a liquid coolant (e.g., water ethylene glycol). One type of vehicle using such a cooling system 100 includes one or more motors 102, an occupant cabin thermal conditioning system 104, a charging system 106, and a battery 108. One or more cooling loops 110 circulate the coolant through these components. Typically, multiple heat exchangers 112 are disbursed throughout the cooling loops 110 to provide a heat exchange from the coolant to another fluid such as air or another liquid coolant. One or more pumps 114 circulate the coolant through the cooling loops 110.

Multiple fluid distribution valves 115 connect multiple passages to selectively regulate the flow of coolant, and thus its temperature, through the cooling loops 110. The fluid distribution valves 115 are distributed throughout the cooling loops 110 as well as throughout the vehicle. Numerous temperature sensors 116 are also dispersed throughout the cooling system 100 to monitor the temperature at various locations in order to enable coordination of the various components to achieve desired temperatures throughout the system.

The example cooling systems 100 illustrate highly distributed architectures, which result in the system components being widely dispersed through the vehicle. This approach can introduce significant design, installation and maintenance costs to the cooling system. A disclosed fluid distribution manifold 118 contains multiple valves and one or more sensors to provide a centralized control system to provide a more reliable, cost effective cooling system architecture. Other components (e.g., pump, controller) can be mounted to the manifold 118 in furtherance of the goal of providing a compact, centralized cooling system. Cooling lines then can be run from the manifold 118 more directly to the components in need of thermal regulation.

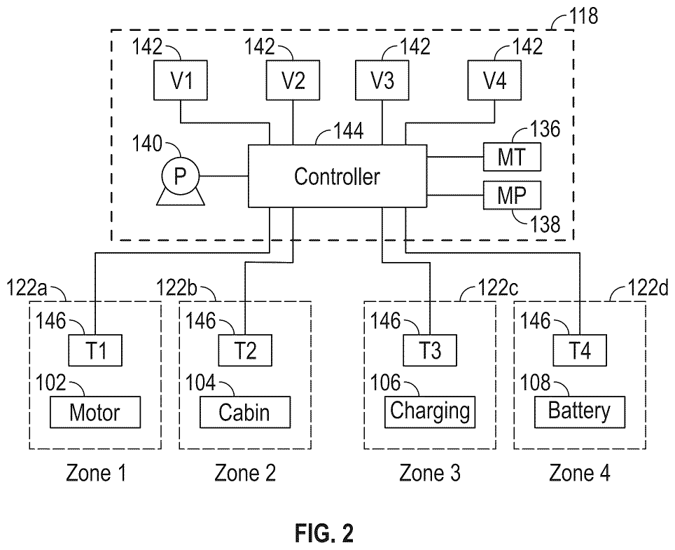

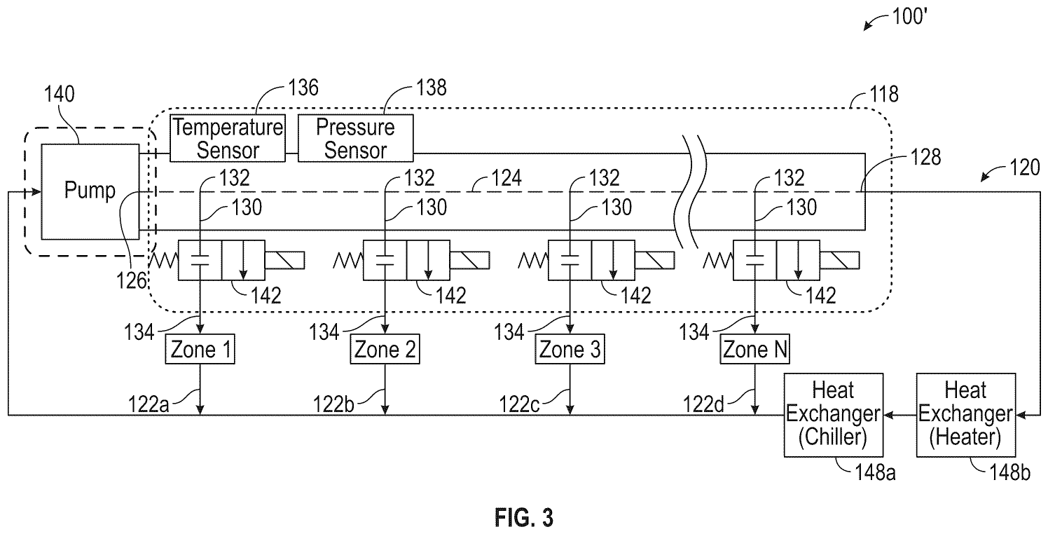

Referring to FIGS. 2 and 3, the manifold 118 is provided by a housing including a primary passageway 124 extending between a primary inlet 126 and a primary outlet 128. The cooling system 100 in which the manifold is incorporated may include a main cooling loop 120 (e.g., fluidly outermost loop) that is in fluid communication with the primary outlet 128 and returns the coolant to the primary inlet 126. A pump 140 may mounted to the manifold 118 (e.g., at the primary inlet 126 or primary outlet 128), if desired, to circulate the coolant through the main cooling loop 120 and one or more zone cooling loops 122, for example. Other pumps may be provided on the manifold 118 for circulating coolant to the zones.

The manifold housing also has multiple secondary passageways 130 each fluidly connected to and fed by the primary passageway 124 at a secondary inlet 132. The multiple secondary passageways 130 each include a secondary outlet 134 on the housing in fluid communication with a zone cooling loop 122, which is fluidly interconnected between the manifold 118 and the main cooling loop 120. The zone cooling loops 122 (e.g., zone loops 122a, 122b, 122c, 122d) thermally regulate components such as a 108 battery, a vehicle cabin thermal conditioning system 104, charging electronics 106, and a motor 102. The main cooling loop 120 may include one or more heat exchangers 148a, 148b.

Multiple valves 142 are supported by the housing, for example, removably mounted to an exterior of the manifold 118. In one example, the valves 142 may be provided by solenoids. Latching solenoid valves can be used to avoid continuous solenoid current flow in any mode of operation. In the example, each of the secondary passageways 130 has a valve 142 arranged fluidly between the secondary inlet 132 and the secondary outlet 134 to regulate fluid flow through its respective secondary passageway 130 and, thus, to its respective zone cooling loop 122. The zone cooling loops 122 may include a zone temperature sensor 146 (FIG. 2), which may be in close proximity to the component to be thermally conditioned. In the example, the manifold 118 includes at least three secondary passageways 130 and a related number of valves, i.e., three valves. In another example, the manifold 118 includes at least four secondary passageways 130 and a related number of valves, i.e., four valves.

The manifold 118 includes, for example, at least one temperature sensor 136 and/or pressure sensor 138 (e.g., both) in fluid communication with the primary passageway 124, which monitors the coolant characteristics in the main cooling loop 120 at the manifold 118. The sensor(s) 136, 138 are mounted to the housing. Additionally or alternatively, a temperature and/or pressure sensor can be provided in the secondary passageways 130 to monitor the coolant characteristics in the respective zone cooling loop 122 at the manifold 118. Such sensors may be integrated into the valve 142, if desired.

A controller 144 can be mounted to the housing of manifold 118. The controller 144 is in communication with the valves 142, sensor(s) 136, 138, and pump 140 (if used) and other components of the cooling system, if desired. The controller 144 is configured to command a position of each of the valves 142 to provide the coolant at a temperature suitable for its respective zone.

The controller 144 may be a hardware device for executing software, particularly software stored in memory. The controller 144 can be a custom made or commercially available processor, a central processing unit (CPU), an auxiliary processor among several processors associated with the controller, a semiconductor-based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. The memory can also have a distributed architecture, where various components are situated remotely from one another, but can be accessed by the processor.

In terms of hardware architecture, such a computing device can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The disclosed input and output devices that may be coupled to system I/O interface(s) may include input devices, for example but not limited to, a keyboard, mouse, scanner, microphone, camera, mobile device, proximity device, etc. Further, the output devices, for example but not limited to, a printer, display, etc. Finally, the input and output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the controller 144 is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

The disclosed coolant manifold 118 can measure inputs including temperature and/or pressure of the coolant fluid to determine the status of the cooling system and control each zone cooling loop individually by opening the valve 142 connected to the zone in need of cooling or heating. This allows for the coolant manifold 118 to utilize heat generated in “hot” zones and send the heated coolant to “cold” zones that need heat. The inverse is also possible with this system to cool the “hot” zones that need cooling. Heating and cooling of the coolant can be contained internally or externally to this coolant manifold 118. The coolant manifold 118 could also include pump control.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A fluid distribution manifold for a vehicle cooling system, comprising:
a housing including a primary passageway extending between a primary inlet and a primary outlet configured to be in fluid communication with a main cooling loop, the housing having multiple secondary passageways each fluidly connected to the primary passageway at a secondary inlet, the multiple secondary passageways each having a secondary outlet configured to be in fluid communication with a zone cooling loop;
multiple valves supported by the housing, each of the secondary passageways having one of the multiple valves arranged fluidly between the secondary inlet and the secondary outlet to regulate fluid flow through its respective secondary passageway; and
a least one temperature sensor or pressure sensor in fluid communication with the primary passageway.

2. The manifold of claim 1, wherein the at least one temperature sensor or pressure sensor includes at least one temperature sensor and at least one pressure sensor mounted to the housing.

3. The manifold of claim 1, comprising a pump mounted to the housing and in fluid communication with the primary passageway and configured to circulate a coolant through at least one of the main cooling loop and the zone cooling loop.

4. The manifold of claim 1, comprising at least three secondary passageways, wherein the multiple valves include at least three valves.

5. The manifold of claim 4, comprising at least four secondary passageways, wherein the multiple valves include at least four valves.

6. The manifold of claim 1, wherein the multiple valves are each provided by a solenoid valve.

7. The manifold of claim 1, wherein the multiple valves are removably mounted on an exterior of the housing.

8. The manifold of claim 1, comprising a controller mounted to the housing, the controller in communication with the multiple valves and configured to command a position of each of the multiple valves.

9. A vehicle cooling system including the fluid distribution manifold of claim 1, the system comprising the main cooling loop and the multiple zone cooling loops, the multiple zone cooling loops fluidly interconnecting the housing and the main cooling loop.

10. The system of claim 9, comprising at least one heat exchanger fluidly arranged in the main cooling loop.

11. The system of claim 9, comprising a temperature sensor in communication with each of the multiple zone cooling loops.

12. The system of claim 9, wherein the multiple zone cooling loops include at least two of a battery, a vehicle cabin, a charging electronics and a motor.

13. The system of claim 12, wherein the multiple zone cooling loops include at least three of a battery, a vehicle cabin, a charging electronics and a motor.

14. The system of claim 13, wherein the multiple zone cooling loops include a battery, a vehicle cabin, a charging electronics and a motor.

15. The system of claim 9, wherein a coolant is provided in the main cooling loop and the multiple zone cooling loops, the coolant is a water ethylene glycol.
